(19) United States
(12) Patent Application Publication
(10) Pub. No.: US 2013/0168003 A1
(43) Pub. Date: Jul. 4, 2013

(54) PNEUMATIC TIRE

(71) Applicant: Sumitomo Rubber Industries, Ltd., Kobe-shi (JP)

(72) Inventor: Akihiro NISHIMURA, Kobe-shi (JP)

(73) Assignee: SUMITOMO RUBBER INDUSTRIES, LTD., Kobe-shi (JP)

(21) Appl. No.: 13/661,978

(22) Filed: Oct. 26, 2012

(30) Foreign Application Priority Data
Dec. 28, 2011 (JP) 2011-289678

(51) Int. Cl. B60C 9/18

(52) U.S. Cl. 152/527

(57) ABSTRACT

A pneumatic tire comprises a carcass extending between bead portions through a tread portion and sidewall portions, and a band disposed radially outside the carcass in the tread portion. The band is composed of at least one steel cord spirally wound in the tire circumferential direction. The steel cord is made up of five steel filaments having a diameter of 0.2 mm and twisted together to have a 1×5 structure. The five steel filaments include at least one shaped filament shaped before twisted. The steel cord has a compressive stiffness of from 200 to 400 N/mm.

### BACKGROUND OF THE INVENTION

The present invention relates to a pneumatic tire, more particularly to a tread reinforcing band composed of a steel cord having a structure of 1×5×0.2 mm and a special characteristic.

In Japanese Patent Application Publication No. 2001-130218 (corresponding to EP1097824A2), it is suggested to use a steel cord having a structure of 3×3 (for example 3×3×0.17 mm) in a tread reinforcing band of a motorcycle tire in order to improve the cornering performance while maintaining the high-speed straight running stability at high levels.

Meanwhile, in the field of motorcycle tires too, the tires are required to reduce the weight and rolling resistance in order to improve fuel consumption performance. Therefore, to meet such requirements, the present inventor proposed to use a steel cord having a structure of 1×5×0.2 mm in a tread reinforcing band of a motorcycle tire. In this cord, the number of the filaments is five, thus relatively less, but the filament diameter is 0.2 mm, thus relatively large. As a result, a necessary tread rigidity can be obtained to achieve the steering stability almost same levels as the band cord having the 3×3×0.17 mm structure disclosed in JP-A-2001-130218. Further, since the number of the filaments is less and the twist structure is most compact, the diameter of the cord becomes decreased. Accordingly, it is possible to decrease the thickness of the band. Further, the amount of steel used in the cord becomes decreased. Therefore, the tire weight can be reduced.

If such 1×5×0.2 mm steel cord is used in the band of a motorcycle tire, there is a tendency that, during manufacturing the tire, undulation is caused in the cords in the band, and as a result, the quality of the vulcanized tire becomes inferior.

In the case of a motorcycle tire whose tread portion is curved with a relatively small radius of curvature, the circumference of the band decreases at a considerably large rate from the center at the tire equator toward the axial edges. As a result, there is a possibility that, during vulcanization, an axially outer cord is subjected to a larger compressive force in comparison with an axially inner cord. Accordingly, if the compressive stiffness of the band cord is high for the compressive force, the band cord can not absorb the compressive force, and meandering is caused. As a result, the band in the vulcanized tire is undulated in the tire radial direction, and the tire quality is deteriorated.

The present inventor therefore proposed to include a shaped steel filament in the five steel filaments of the band cord in order to decrease the compressive stiffness and thereby to prevent the undulation of the band. However, if the number of the shaped filament(s) and the degree of the shaping are too much, the compressive stiffness of the cord is excessively decreased, and it becomes difficult to secure the required steering stability. Therefore, when a steel cord having a structure of 1×5×0.2 mm is employed in a tread reinforcing band, it is important to define the upper limit and lower limit of the compressive stiffness.

### SUMMARY OF THE INVENTION

It is therefore, an object of the present invention to provide a pneumatic tire in which a steel cord, which have a 1×5×0.2 mm structure and includes a shaped filament, is used as a band cord and the compressive stiffness of the cord is limited in a specific range to prevent meandering of the band cord and undulation of the band and at the same time to secure an excellent steering stability while achieving a decrease in the rolling resistance and a weight reduction.

According to the present invention, a pneumatic tire comprises

a carcass extending between bead portions through a tread portion and sidewall portions, and

a band disposed radially outside the carcass in the tread portion, and composed of at least one steel cord spirally wound in the tire circumferential direction,

wherein

the steel cord is made up of five steel filaments having a diameter of 0.2 mm and twisted together to have a 1×5×0.2 mm structure,

the five steel filaments include at least one shaped filament shaped before twisted so that the steel cord has a compressive stiffness of from 200 to 400 N/mm.

Preferably, the shaped filament has a shaping height of from 0.1 to 0.3 mm. The five steel filaments preferably include two or more shaped filaments.

Here, the compressive stiffness is defined as follows. First, two specimens are prepared. One is made of a cylindroid rubber having a diameter of 25 mm and a height of 25 mm. The other is identical to the former except that one cord having a length of 25 mm is embedded along the central axis thereof. Then, the specimen is set on a horizontal plane with one end contacting therewith, and a compressive force is applied to the other end though a plate having a flat surface with which the other end contacts and which is parallel with the horizontal plane. The compressive force required to compress 1 mm in the height direction is measured for each specimen to calculate the difference (F1−F2) of the compressive force F1 obtained from the specimen with the cord from the compressive force F2 obtained from the specimen without the cord. The compressive stiffness of the band cord can is defined by the difference (F1−F2).

### BRIEF DESCRIPTION OF THE DRAWINGS

FIG. 1 is a cross sectional view of a pneumatic tire as an embodiment of the present invention.

FIG. 2 is a perspective partial view of a raw rubber tape in which band cords are embedded.

FIG. 3 is a schematic cross sectional view of a band cord.

FIG. 4 is a side view of a shaped filament.

### DESCRIPTION OF THE PREFERRED EMBODIMENTS

Embodiments of present invention will now be described in detail in conjunction with accompanying drawings.

The pneumatic tire 1 according to the present invention comprises a tread portion 2, a pair of sidewall portions 3, a pair of bead portions 4 each with a bead core 5 therein, a carcass 6 extending between the bead portions 4 through the tread portion 2 and sidewall portions 3, and a band 7 disposed radially outside of the carcass 6 in the tread portion 2.

The carcass 6 is composed of at least one ply 6A of organic fiber cords, for example nylon, polyester, rayon and the like, arranged at an angle of from 60 to 90 degrees with respect to the tire circumferential direction.

In this example, the carcass 6 is composed of a single ply of organic fiber cords arranged at substantially 90 degrees.

The carcass ply 6A extends between the bead portions 4 through the tread portion 2 and sidewall portions 3, and turned up around the bead core 5 in each bead portion from the inside to the outside of the tire to form a pair of turned up portions 6b and a toroidal main portion 6a therebetween.

In each of the bead portions 4, a bead apex rubber 8 is disposed between the turned up portion 6b and the main portion 6a to extend radially outwardly from the bead core 5 in a tapered manner and to reinforce the bead portions.

The band 7 is composed of at least one ply 7A of at least one band cord 10 spirally wound a large number of times in the tire circumferential direction. In this example, the band 7 is composed of a single ply 7A.

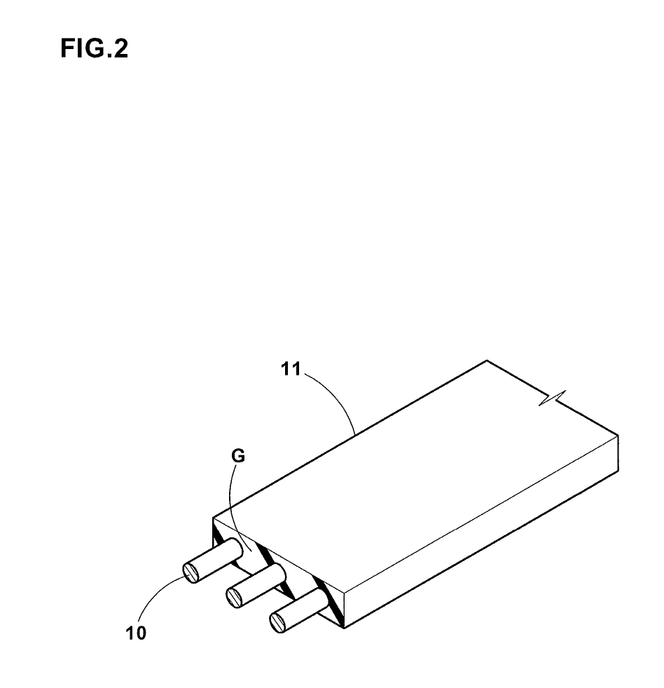

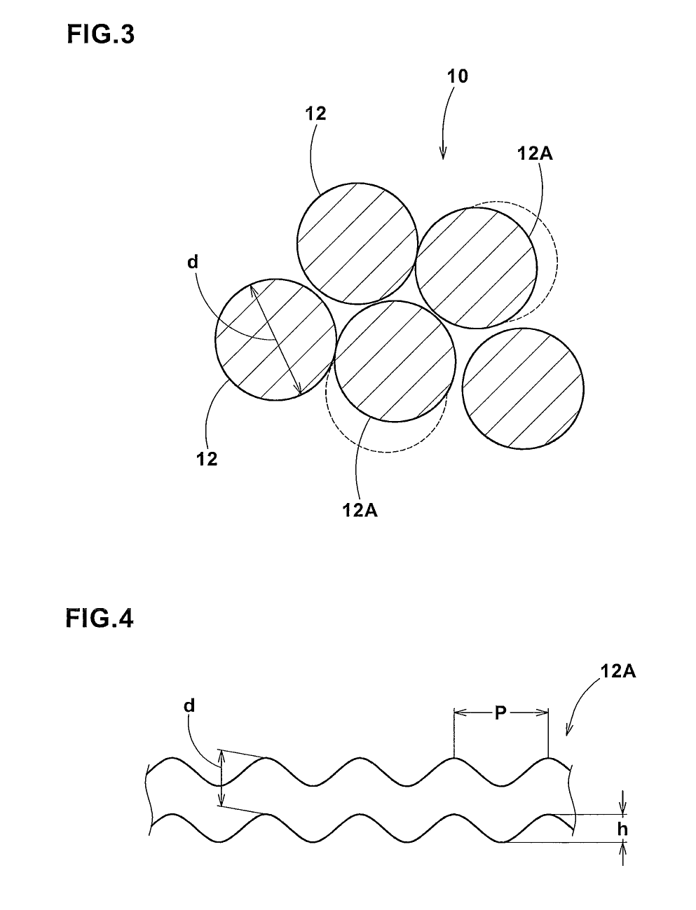

The band ply 7A is formed by spirally winding a large number of times a rubber tape 11 in which a single band cord 10 or a plurality of parallel band cords 10 are covered with topping rubber G in the form of a tape considerably narrower in width than the ply 7A as shown in FIG. 2.

In the drawings, the pneumatic tire 1 is designed as a motorcycle tire. Therefore, in the meridian section of the tire, the tread portion 2 (inclusive of the carcass 6, band 7 and a tread rubber thereon) is curved with a relatively small radius of curvature when compared with the passenger car tires, truck/bus tires and the like. As a result, the maximum cross section width of the tire lies between the tread edges Te. In other words, the maximum cross section width is equal to the tread width TW.

However, it is also possible to apply the present invention to pneumatic tires for four-wheel vehicles. In this case, usually, between the band 7 and the carcass 6, there is disposed a breaker composed of at least two cross plies of parallel cords (organic fiber cords or steel cords) laid at an angle of 10 to 60 degrees with respect to the tire circumferential direction.

Further, in the case of a motorcycle tire too, between the band 7 and the carcass 6, it is possible to dispose a belt composed of one or two plies of parallel cords (organic fiber cords or steel cords) laid at an angle of 10 to 60 degrees with respect to the tire circumferential direction.

The band cord 10 is a steel cord having a 1×5 structure in which five steel filaments 12 in a bunch are twisted in one direction. All of the five steel filaments 12 have a diameter (d) of 0.2 mm. Thus, the cord structure is 1×5×0.2 mm.

As for the material of the steel filament 12, preferably used are the piano wire rods whose chemical compositions are specified in Japanese Industrial standard JIS 63502, and the high-carbon steel wire rods specified in JIS 63506.

The steel filament 12 is preferably coated with copper, stannum, zinc or an alloy including at least one of them in order to improve the adhesion to the topping rubber.

The five steel filaments 12 include at least one shaped filament 12A.

The shaped filament 12A is shaped before twisted.

It is desirable that, as shown in FIG. 4, the shaped filament 12A is waved two dimensionally to have alternate peaks and troughs.

By adjusting the number of the shaped filament(s) 12A in the cord and/or the degree of shaping applied to the shaped filament, the compressive stiffness of the band cord 10 is set in a range of not less than 200 N/mm, preferably not less than 300 N/mm, but not more than 400 N/mm.

If the compressive stiffness is more than 400 N/mm, then the meandering and undulation are liable to occur. If the compressive stiffness is less than 200 N/mm, then the tire lacks rigid feeling and decreases in the steering stability.

As described above, in the tire according to the present invention, the number of the filaments constituting a band cord 10 is five which is relatively less, but the diameter (d) of the filaments is 0.2 mm which is relatively large.

Therefore, the band is provided with sufficient rigidity capable of exerting excellent steering stability.

Meanwhile, since the number of the filaments is five and the twist structure is 1×5 which makes the cord most compact, the cord diameter becomes decreased and thereby the thickness of the band 7 can be decreased. In addition, the amount of steel used in the cord can be reduced, therefore, it is possible to reduce the tire weight. Further, since the compressive stiffness of the band cord 10 is limited to a specific range 200 to 400 N/mm by the use of the shaped filament 12A, the undulation of the band cord can be prevented in order not to deteriorate the tire quality, while achieving the excellent steering stability and weight reduction.

The compressive stiffness can be decreased by increasing the number of the shaped filaments 12A. If the number of the shaped filament 12A is one, there is a possibility that the compressive stiffness can not be effectively decreased. Therefore, it is preferable that the number of the shaped filaments 12A is not less than 2, more preferably not less than 3.

The shaping which is applied to the shaped filament 12A is a minute shaping such that the shaping height (h) (corresponding to a peak-to-peak maximum amplitude of zigzag of the axis of the filament as shown in FIG. 4) is not less than 0.10 mm, preferably not less than 0.12 mm, but not more than 0.30 mm, preferably not more than 0.25 mm. Further, the shaping pitch length P is preferably set in a range of not less than 0.10 mm but not more than 0.50 mm.

If the shaping height (h) is less than 0.10 mm, then it is difficult to obtain the necessary compressive stiffness. In addition, it becomes difficult for the topping rubber to sufficiently penetrate into the cord, and as a result, there is a possibility that the high-speed durability after the tire is subjected to heat and humidity is decreased. If the shaping height (h) exceeds 0.30 mm, there is a tendency that the cord is caught on the rubber topping machine.

If the shaping pitch length P is less than 0.1 mm, then it becomes difficult to obtain the required compressive stiffness. In addition, it becomes difficult for the topping rubber to sufficiently penetrate into the cord. As a result, there is a possibility that the high-speed durability after subjected to heat and humidity is decreased. If the shaping pitch length P exceeds 0.5 mm, there is a possibility that the steering stability is deteriorated.

If the filament diameter (d) is more than 0.2 mm, it is difficult to set the compressive stiffness in the above-mentioned range 200 to 400 N/mm. Further, the cord lacks flexibility and the fatigue resistance becomes insufficient for a cord of the band. If the filament diameter (d) is less than 0.2 mm, it is difficult to obtain the tensile strength and bending rigidity necessary for the band cord.

In this embodiment, the cord count of the band 7 as a whole is set in a range of from 30 to 45 ends/5 cm.

### Comparison Tests

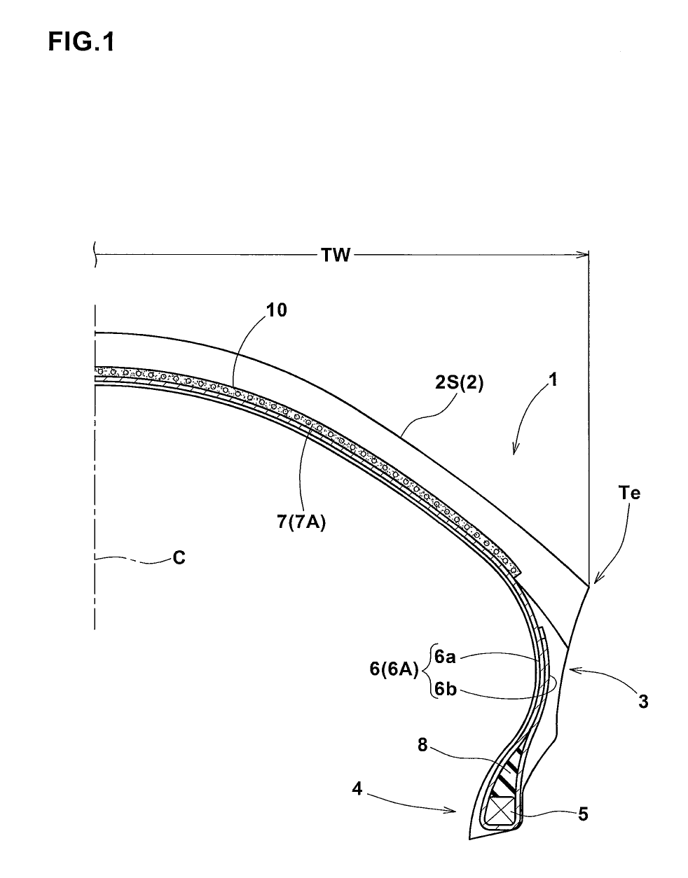

Motorcycle tires (for rear wheel) of size 160/60zR17 (rim size MT6.00×17) having the structure shown in FIG. 1 were experimentally manufactured and tested for the rolling resistance, steering stability and tire quality.

All of the tires had the same specifications except for the band cords of which specifications are shown in Table 1.

Common specifications to all of the bands are as follows: the thickness of topping rubber covering the cords in the rubber tape was 0.1 mm; the cord count of the band was 37.5 ends/5 cm; the steel filaments were a high-carbon steel wire according to JIS G3506; and the shaped filament was two-dimensionally shaped (waved).

The weight of the tire is indicated in Table 1 by an index based on Comparative example tire Ref.1 being 100.

### <Rolling Resistance Test>

Using a tire rolling resistance testing machine, the rolling resistance was measured under the following conditions: tire pressure 250 kPa, tire load 3.43 kN, and speed 80 km/h. The results are indicated in Table 1 by an index based on comparative example tire Ref.1 being 100, wherein the smaller the index number, the better the rolling resistance.

### <Steering Stability Test>

The test tire was attached to a large sports bike (1000 cc) and run on a dry asphalt road in a tire test course. (tire pressure 250 kPa) Based on the maneuverability, cornering behavior, ride comfort and the like, the steering stability was evaluated into ten ranks by the test rider, wherein the higher the rank number, the better the steering stability. The acceptance line is 8 or higher.

### <Tire Quality Test>

The tires were visually checked whether radial undulation of the band was caused or not. The number of tires with undulation observed per 100 tires is shown in Table 1.

### <High-Speed Durability Test>

The test tires were placed in a room whose temperature and relative humidity were controlled at 80 deg.C and 98%, for 150 hours to be subjected to hygrothermal aging. Then, the test tire was subjected to an indoor wheel test prescribed by the Procedure for Load/speed Performance Tests of the Economic commission for Europe (ECE-30). The running speed was increased, and the speed at which any failure occurred was measured.

The results are indicated in Table 1 by an index based on Comparative example tire Ref.1 being 100, wherein the larger the index number, the better the high-speed durability after hygrothermal aging.

As shown in Table 1, according to the present invention, the undulation of the band can be prevented and the rolling resistance can be decreased, while achieving excellent steering stability and weight reduction.

TABLE 1

| Tire | | | | | | | | |
|---|---|---|---|---|---|---|---|---|
| Band cord | Ref. 1 | Ref. 2 | Ex. 1 | Ex. 2 | Ex. 3 | Ex. 4 | Ref. 3 | Ex. 5 |
| structure | 3 × 3 | 1 × 5 | 1 × 5 | 1 × 5 | 1 × 5 | 1 × 5 | 1 × 5 | 1 × 5 |
| filament diameter d (mm) | 0.17 | 0.2 | 0.2 | 0.2 | 0.2 | 0.2 | 0.2 | 0.2 |
| number of shaped filaments | 0 | 5 | 4 | 3 | 2 | 1 | 1 | 3 |
| shaping height h (mm) | — | 0.12 | 0.12 | 0.12 | 0.12 | 0.12 | 0.12 | 0.05 |
| shaping pitch length P (mm) | — | 0 | 0.5 | 1 | 0.4 | 0.5 | 1 | 0.5 |
| compressive stiffness (N/mm) | 70 | 150 | 200 | 250 | 300 | 400 | 450 | 300 |
| tire weight | 100 | 80 | 80 | 80 | 80 | 80 | 80 | 80 |
| rolling resistance | 100 | 85 | 78 | 85 | 75 | 76 | 70 | 75 |
| tire quality | 0 | 3 | 3 | 3 | 6 | 90 | 95 | 5 |
| steering stability | 8 | 6.5 | 8 | 8 | 9 | 8 | 6 | 9 |
| high-speed durability | 100 | 120 | 119 | 117 | 110 | 105 | 107 | 114 |
| Tire | | | | | | | | |
| Band cord | Ex. 6 | Ex. 7 | Ex. 8 | Ex. 9 | Ex. 10 | Ex. 11 | Ex. 12 | Ex. 13 |
| structure | 1 × 5 | 1 × 5 | 1 × 5 | 1 × 5 | 1 × 5 | 1 × 5 | 1 × 5 | 1 × 5 |
| filament diameter d (mm) | 0.2 | 0.2 | 0.2 | 0.2 | 0.2 | 0.2 | 0.2 | 0.2 |
| number of shaped filaments | 3 | 2 | 2 | 2 | 3 | 3 | 4 | 5 |
| shaping height h (mm) | 0.10 | 0.25 | 0.30 | 0.35 | 0.12 | 0.25 | 0.2 | 0.25 |
| shaping pitch length P (mm) | 0.3 | 0.4 | 0.5 | 0.1 | 0.05 | 0.1 | 0.5 | 1 |
| compressive stiffness (N/mm) | 300 | 300 | 300 | 300 | 300 | 300 | 300 | 300 |
| tire weight | 80 | 80 | 80 | 80 | 80 | 80 | 80 | 80 |
| rolling resistance | 75 | 75 | 75 | 76 | 76 | 76 | 76 | 76 |
| tire quality | 5 | 6 | 5 | 98 | 10 | 10 | 10 | 10 |
| steering stability | 9 | 9 | 8 | 8.5 | 8.5 | 8.5 | 8.5 | 7 |
| high-speed durability | 116 | 125 | 113 | 110 | 103 | 125 | 115 | 120 |

1. A pneumatic tire comprising
a carcass extending between bead portions through a tread portion and sidewall portions, and
a band disposed radially outside the carcass in the tread portion and composed of at least one steel cord spirally wound in the tire circumferential direction,
wherein
the steel cord is made up of five steel filaments having a diameter of 0.2 mm and twisted together to have a 1×5×0.2 mm structure,
the five steel filaments include at least one shaped filament shaped before twisted so that the steel cord has a compressive stiffness of from 200 to 400 N/min.

2. The pneumatic tire according to claim 1, wherein
the shaped filament has a shaping height of from 0.1 to 0.3 mm.

3. The pneumatic tire according to claim 1 or 2, wherein
the five steel filaments include two or more shaped filaments.

4. The pneumatic tire according to claim 1, which is a motorcycle tire of which maximum cross sectional width lies between tread edges of the tread portion curved convexly in a tire meridian section.
